(19) United States
(12) Patent Application Publication
(10) Pub. No.: US 2012/0010818 A1
(43) Pub. Date: Jan. 12, 2012

(54) Collecting Control Source Electromagnetic Signals

(76) Inventor: Alexander Edward Kalish, The Woodlands, TX (US)

(21) Appl. No.: 13/178,477

(22) Filed: Jul. 7, 2011

Related U.S. Application Data
(60) Provisional application No. 61/362,241, filed on Jul. 7, 2010.
(60) Provisional application No. 61/366,916, filed on Jul. 22, 2010.

(51) Int. Cl. G01V 3/12

(52) U.S. Cl. 702/6

(57) ABSTRACT

Concurrently measuring, correlating, and processing magnetic and electric field data includes measuring base band signals, and then up-converting those band signals to a higher frequency for filtering, while at the same time preserving phase and amplitude information. All timed elements in the system are rigorously synchronized. The increased data set results in improved signal-to-noise ratio and information correlation.

### CROSS-REFERENCE TO RELATED APPLICATIONS

This patent application claims the benefits of provisional patent application Ser. No. 61/362,241, filed Jul. 7, 2010, and provisional patent application Ser. No. 61/366,916, filed Jul. 22, 2010.

### STATEMENT REGARDING FEDERALLY SPONSORED RESEARCH OR DEVELOPMENT

None.

### THE NAMES OF THE PARTIES TO A JOINT RESEARCH AGREEMENT

None.

### INCORPORATION-BY-REFERENCE OF MATERIAL SUBMITTED ON A COMPACT DISC

None.

### BACKGROUND OF THE INVENTION

(1) Field of the Invention

The invention relates to devices and processes for geophysical prospecting, and, more particularly, to the removal of noise typically associated with the data collection of Control Source Electromagnetic (“CSEM”) and Magnetoturelic (“MT”) signals.

(2) Description of Related Art (Including Information Disclosed Under 37 CFR 1.97 and 1.98)

There are many U.S. patents and patent applications related to electromagnetic surveying. Some of the more relevant ones appear to be the following: U.S. Pat. No. 6,253,100, for broad band electromagnetic holographic imaging; U.S. Pat. No. 7,203,599, for acquiring transient electromagnetic survey data; U.S. Pat. No. 7,337,064, for electromagnetic surveying for hydrocarbon reservoirs; U.S. Pat. No. 7,483,792, for electromagnetic surveying for hydrocarbon reservoirs; U.S. Pat. No. 7,502,690, for using time-distance characteristics in acquisition of t-CSEM data; U.S. Pat. No. 7,565,245, for electromagnetic surveying; U.S. Pat. No. 7,805,249, for controlled source electromagnetic surveying with multiple transmitters; U.S. Pat. No. 7,822,562, for removing air wave noise from electromagnetic survey data; U.S. Pat. No. 7,941,273, for using time-distance characteristics in acquisition of T-CSEM data; 20080105425, for electromagnetic surveying for hydrocarbon reservoirs; 20090005994, for time lapse analysis with electromagnetic data; 20090005997, for spatial filtering of electromagnetic survey data; 20090067546, for compensating electromagnetic data; 20090072831, for real time monitoring of the waveform transmitted by an electromagnetic survey; 20090082970, for electromagnetic surveying; 20090103395, for wavelet denoising of controlled source electromagnetic survey data; 20090120636, for controlled source electomagnetic surveying with multiple transmitters; 20090126939, for electromagnetic data processing system; 20090204330, for using time-distance characteristics in acquisition of T-CSEM data; 20090265111, for signal processing of marine electromagnetic signals; 20090276189, for estimating noise at one frequency by sampling noise at other frequencies; 20100018719, for inversion of CSEM data with measurement system signature suppression; 20100065266, for controlled source electromagnetic reconnaissance surveying; 20100176791, for correcting the phase of electromagnetic data; 20100224362, for electromagnetic imaging by four dimensional parallel computing; 20100233955, for electromagnetic air-wave suppression by active cancellation; 20110013481, for detecting marine deposits; and 20110087435, for electromagnetic prospecting waveform design. All of these patents and patent applications are incorporated herein by this reference.

Several techniques exist that attempt to remove air wave noise and other noise sources from the signal of interest in a CSEM system. These techniques include active filtering, signal encoding such as grey coding, and noise estimation and subtraction at different frequencies. Additionally, until recently, all of these techniques were supplemented by physical isolation of the receiving elements from the noise source, by submersion in a marine environment, thus using the water as an air wave signal filter. These methods are typified in the above-listed U.S. patent applications 2009/0204330, 2009/0265111, 2009/0276189, 2011/0013481, and in U.S. Pat. No. 7,822,562.

The major problem with these techniques is that they are unable to successfully filter out in-frequency noise because the frequency of interest is very close to the frequency of the noise, that is, typically between fifty and sixty hertz (50-60 hz).

In addition, for the purposes of operation on the surface, there are many more sources of noise and amplification of noise, such as rail lines, pipelines and barbed wire fences, that is, anything that is ferrous and long. The typical solution to these noise problems is to survey the area before performing a CSEM survey, and remove the known anomalies from the data. Items can be missed in the preliminary survey, causing additional unexpected noise in the data, and thus reducing delineation and depth of investigation. A person skilled in the art of performing CSEM surveying will understand the issues that uncontrolled noise can cause when using existing systems for surface based measurements. The use of CSEM for surveying is described in U.S. Pat. No. 7,203,599.

In light of the foregoing, a need remains for a system and method of visualizing sub-surface formations that reduces noise, and improves resolution.

### BRIEF SUMMARY OF THE INVENTION

The present invention improves the visualization of sub-surface formations in a static state by reducing noise, and improving resolution. Multiple simultaneous channels of E and H field data using high speed data acquisition techniques coupled with advanced noise filtering techniques and more precise determination of phase data, allows for the rapid interpretation of 2D, 3D, and 4D data in CSEM operations to greater depths and finer bin resolution.

The receiver system of the present invention is able to detect the transient states being caused by either removing fluid or gas from the formation, or imposing fluid and propant under pressure during fracturing operations.

The invention takes the differential signal and up-converts it to a higher frequency, imposes RF noise filtering techniques at the higher frequency, and preserves both phase and amplitude information from the original signal. The inventive technique allows software to control the frequency at which the system will collect data, and the frequencies of data that are rejected. The method of the present invention, includes a source clock with a low phase jitter. In addition, the current invention implements an enhanced method for obtaining induced magnetic field data that produces improved granularity in formation data.

### BRIEF DESCRIPTION OF THE SEVERAL VIEWS OF THE DRAWINGS

FIG. 1A depicts a receiver layout in the form of a matrix of receivers.

FIG. 1B depicts an alternate receiver layout in the form of a string of receivers.

FIG. 2 Is a block diagram of the modules that are contained within a receiver system.

FIG. 3 is a block diagram of the electric field portion of the receiver system.

FIG. 4 is a block diagram of the magnetic field portion of the receiver system.

FIG. 5 is a block diagram of the timer module of the receiver system.

FIG. 6 is a block diagram of the control module of the receiver system.

FIG. 7 is a flow chart of the logic of the method of the present invention.

In the figures, the left-most significant digit(s) in the reference numerals denote(s) the first figure in which the respective reference numerals appear.

### DETAILED DESCRIPTION OF THE INVENTION

In the preferred embodiment a plurality of receivers are arranged to collect data that is used to create images of the physical features within sub-surface formations. The receiver system measures the potential difference of the decaying electric field signal and surface currents caused by a CSEM transmitter pulse, between at least two widely spaced electrodes that are driven into the ground. In addition the receiver measures the magnetic fields that result from the excitation caused by a CSEM transmitter. The transmitter is a separate device. An example of a CSEM transmitter is a model no. DIT TX50 manufactured and sold by Deep Imaging Technologies, Inc., head-quartered in Houston Tex.

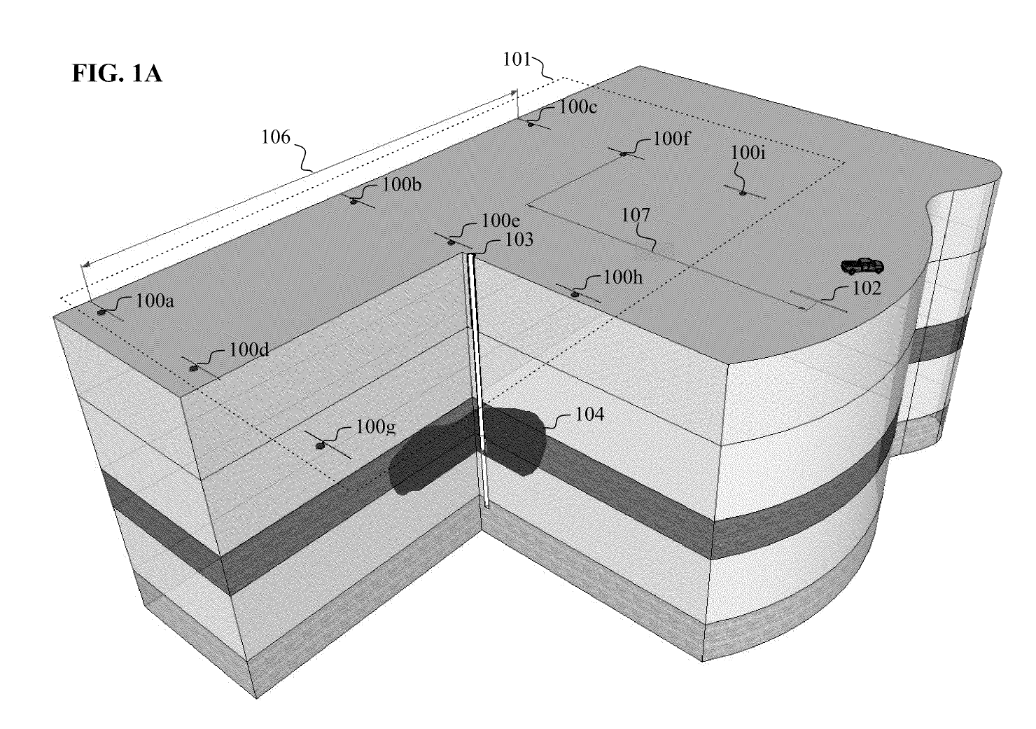

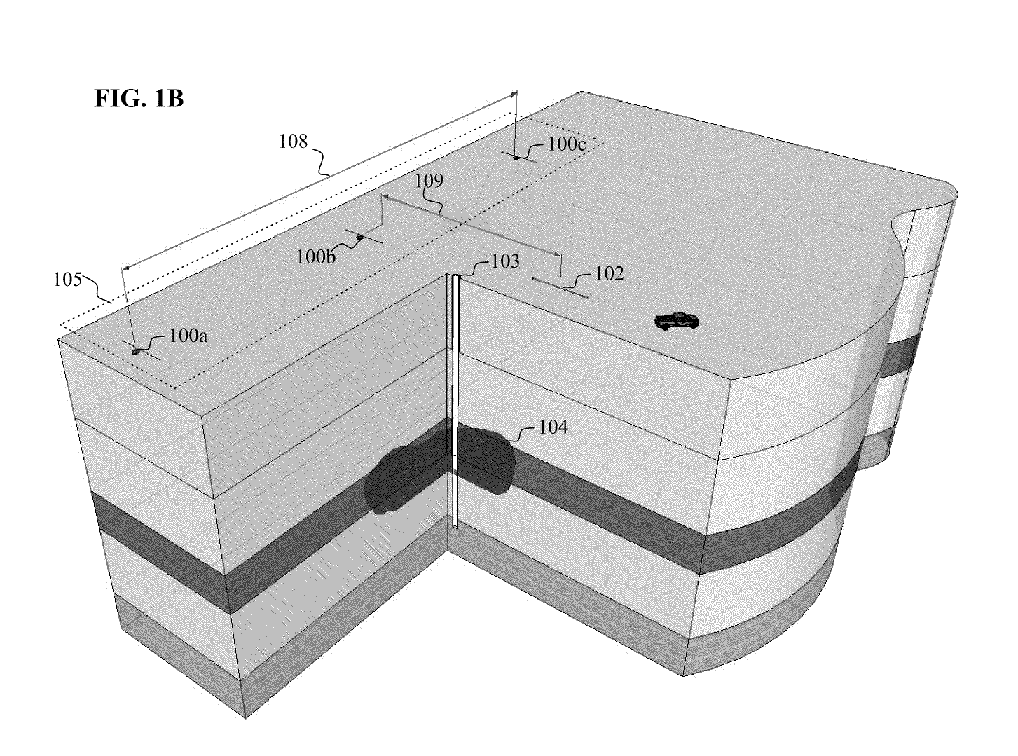

Referring to FIG. 1A, in the preferred embodiment a plurality of time-synchronized receiver systems 100 are assembled as depicted, 100a, 100b, 100c, 100d, 100e, 100f, 100g, 100h and 100i to form a receiver matrix 101 around or offset from a wellhead 103. In a typical setup the receiver matrix 101 extends over an area of one kilometer square 106. Any number of receiver systems 100 can be used to form the matrix 101. A CSEM transmitter 102 is placed in accordance with the requirements of the CSEM survey for a plurality of subsurface formations 104, and is a distance of greater than five hundred meters 107, from the middle of the receiver matrix 101 to ensure the CSEM transmitter 102 is offset from the receiver matrix 101. The requirements for a CSEM survey can be understood by any person familiar with the practice of CSEM surveying.

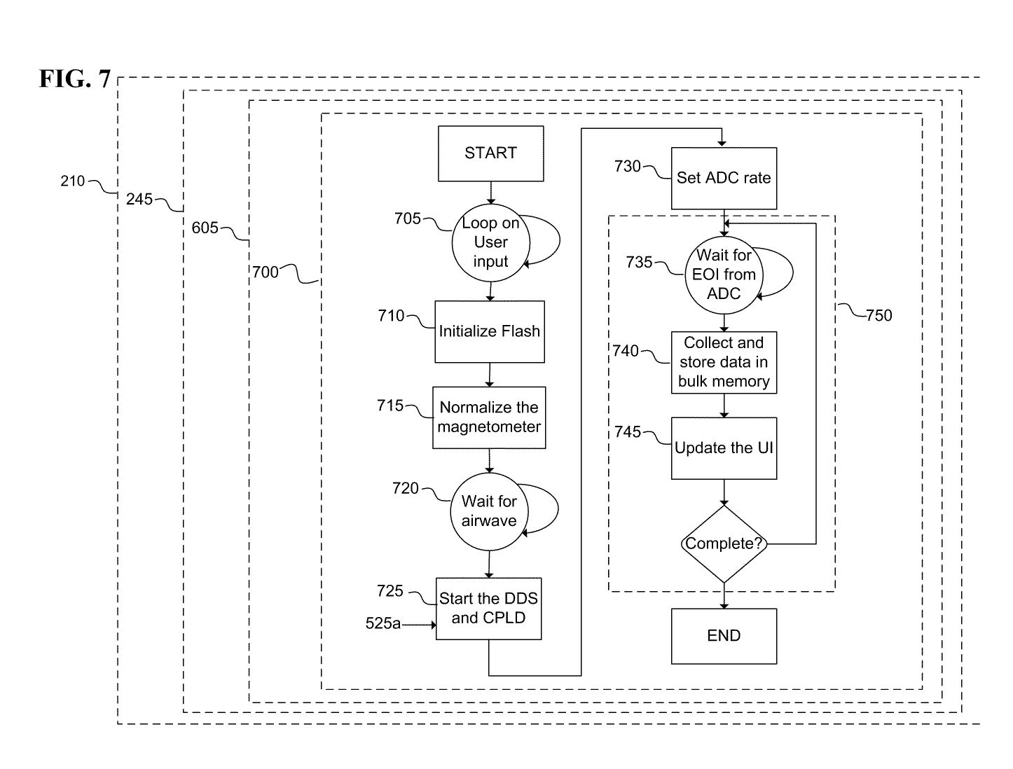

Referring now to FIG. 1B, an alternate embodiment allows for the assembly of a plurality of time-synchronized receiver systems 100 to form a receiver string 105 as depicted by 100a, 100b and 100c. In a typical setup the receiver string 105 extends over a distance of 1 KM 108 and the CSEM transmitter 102 is placed at a distance of approximately 500 meters 109, from the receiver string 105 In a further alternate embodiment at least one receiver string 105 is used in conjunction with the action of repositioning the receiver matrix 100 after each set of data has been received and collected. All of the embodiments of the method of the present invention include the step of accurately locating the receiver systems 100 relative to each other and the CSEM transmitter 102. That step is shown as step 725 in FIG. 7.

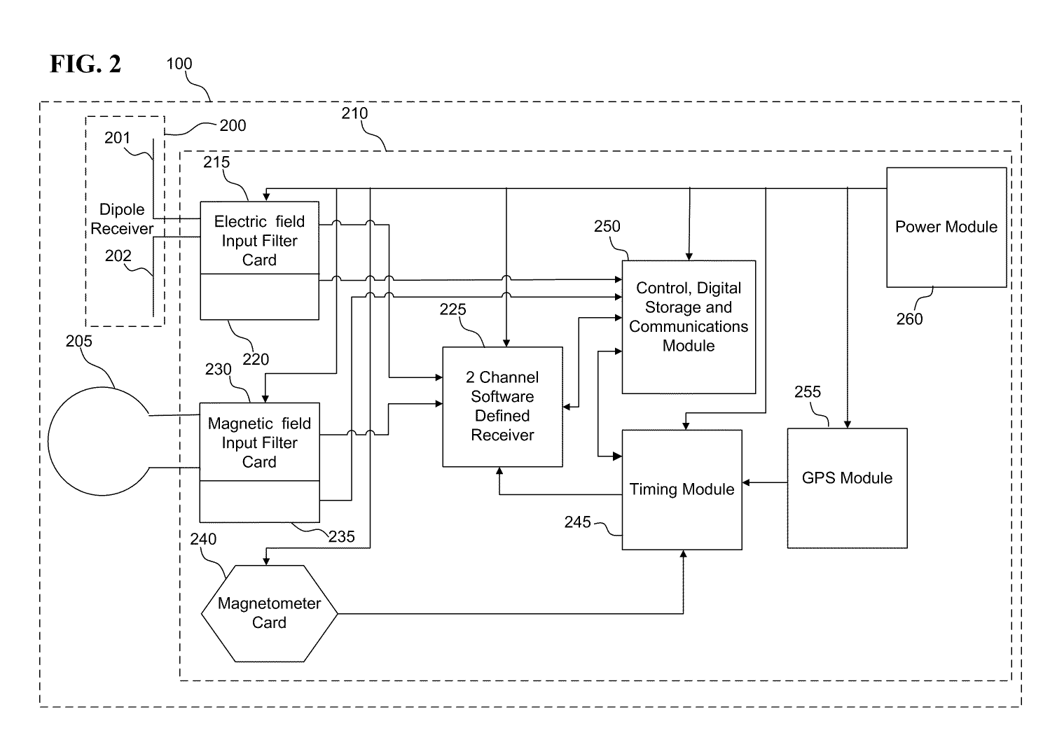

Referring now to FIG. 2, the receiver system 100 includes several sub-systems and sensor groups. In the preferred embodiment, a dipole receiver 200 contains electrodes 201 and 202. A magnetic field loop antenna 205 connects to an electronics assembly 210. The electronics assembly 210 includes an electric field input filter card 215, a surface electric current detector circuit 220, a two-channel Software Defined Receiver (SDR) 225, a magnetic field input filter card 230, a magnetic point potential circuit 235, a Magnetometer Card (MC) 240, a Timing Module (TM) 245, a Control, Digital Storage, and Communications Module. 250, a GPS Module 255 and a Power Module 260.

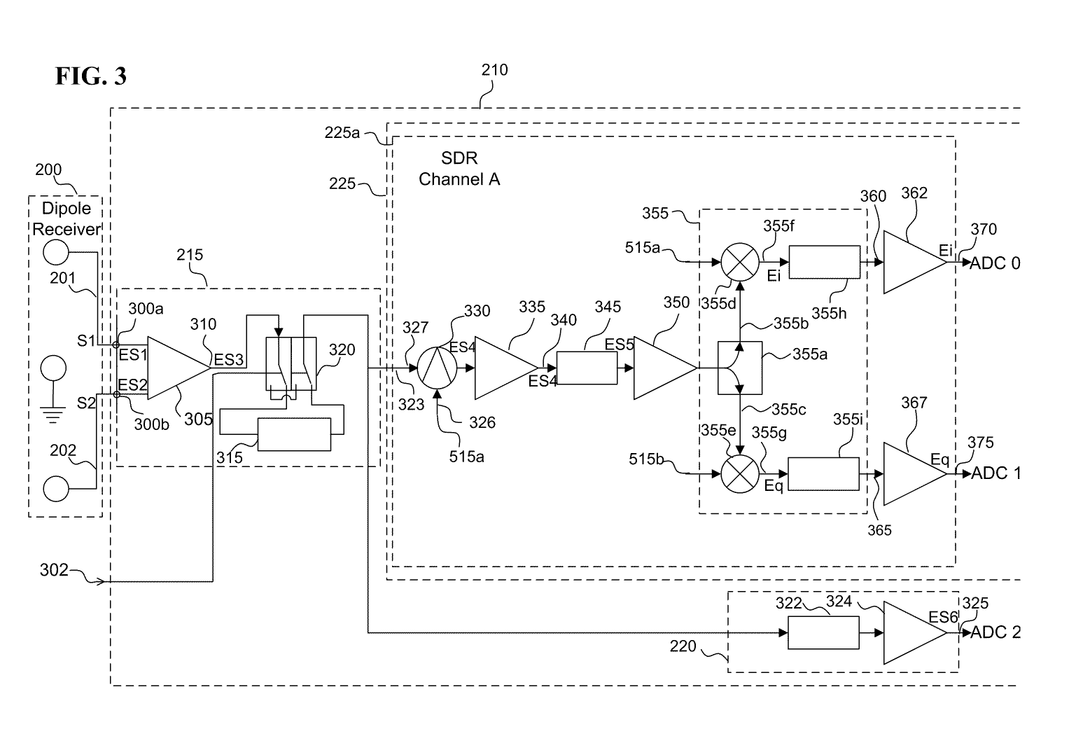

Referring now to FIG. 3, in the preferred embodiment, for each of the receiver systems 100 the two electrodes 201 and 202 are widely spaced and inserted into the surface of the earth. The dipole receiver 200 receives the electric field resulting from a synchronized transmitter pulse. The electrodes 201 and 202 are conductively coupled to a pair of signal inputs 300a and 300b in the electronics assembly 210. A pair of signals, ES1 and ES2 are received through the electrodes 201 and 202, and pass into the E field Input Filter card 215. A common mode amplifier 305 receives the signals ES1 and ES2 and outputs a difference signal ES3 at an output 310. The output 310 is conductively coupled to a power line filter 315. The power line filter 315 can be optionally removed from the circuit through a user activated switch 302, which is connected to a relay switch 320. The output of the power line filter 315 is conductively coupled to an input channel of the SDR 225. Alternatively, the output 310 of the common mode amplifier 305 bypasses the power line filter 315, and conductively couples to a channel of the SDR 225.

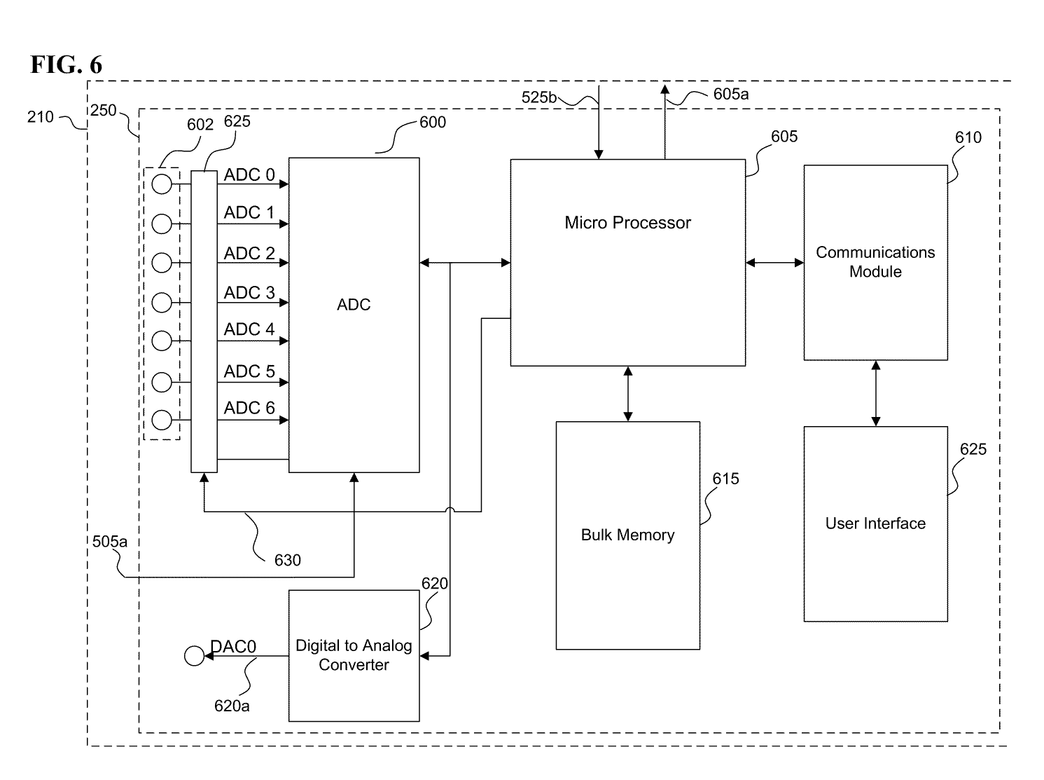

The output 310 is conductively coupled to the surface electric current detector circuit 220, and thus the ES3 signal at the output 310 is passed through a low pass filter 322 and an amplifier 324. An output signal ES6, at an output 325, is the surface electric direct current (DC). The output 325 is conductively coupled to a 24-bit analog-to-digital converter (ADC) 600 shown in FIG. 6.

The difference signal ES3 is present at an input 323 (also known as “Port A” of the actual mixer circuit 330) to a channel 225a of the SDR 225. The difference signal ES3 is passed to a capacitively coupled input 327 of a high dynamic range mixer circuit 330. In the preferred embodiment, the mixer circuit 330 is a MiniCircuits Model SBL-1A+ (DC-100 MHz version), manufactured by MiniCircuits in Brooklyn, N.Y.

Input 326 (also known as “Port B” of the actual MiniCircuits mixer circuit 330) is supplied with a 25 dbm signal 515a, generated from a high stability source in the timing module 245. The frequency of the signal 515a is controlled by software executing in a micro processor in the Control, Digital Storage, and Communications Module 250. The frequency of the signal 515a can be set to any one of a wide range of frequencies. In the preferred embodiment of the present invention the frequency is set to 9 Mhz.

The frequency of the incoming signal ES3 is up-converted by the mixer circuit 330. An output of the mixer circuit 330 is connected conductively to a 40 db gain IF amplifier 335. An output 340 of the IF amplifier 335 is conductively connected to the input of a combination Cohn filter and a diplexer circuit 345. The diplexer circuit is to help with matching and minimal phase distortion. An example of a Cohn filter design is one sold by Clifton Laboratories, Clifton, Va., and can be understood by a person familiar with the art of RF filter design. In an alternate embodiment, the Cohn filter in the Cohn filter and diplexer circuit 345 can be replaced by any RF band pass filter that can be digitally controlled.

The output of the Cohn filter and the diplexer circuit 345 has a signal ES5. The output of the Cohn filter and the diplexer circuit 345 is conductively coupled to a low noise Intermediate Frequency (IF) amplifier 350. In the preferred embodiment, the amplifier 350 is the Analog Devices AD9855, manufactured by Analog Device Inc, Norwood, Mass. 02062-9106. The amplification of the signal ES5, in the IF amplifier 350 stage is 12 db, and is designed to regain the signal loss through the Cohn filter and the diplexer circuit 345.

The output of the IF amplifier 350 is conductively coupled to the input of an Enhanced Tayloe detector (ETD) circuit 355. At the input to the ETD circuit 355 the signal is coupled to a power splitter 355a. The power splitter 355a galvanically isolates two outputs 355b and 355c that are conductively coupled to two separate tayloe detector circuits 355d and 355e respectively. The tayloe detector circuits 355d and 355e are implemented using CMOS components. Using two separate tayloe detector circuits 355d and 355e, for resolving the in-phase and quadrature signals from the same input signal ES5, reduces cross talk and signal noise between two outputs 360 and 365.

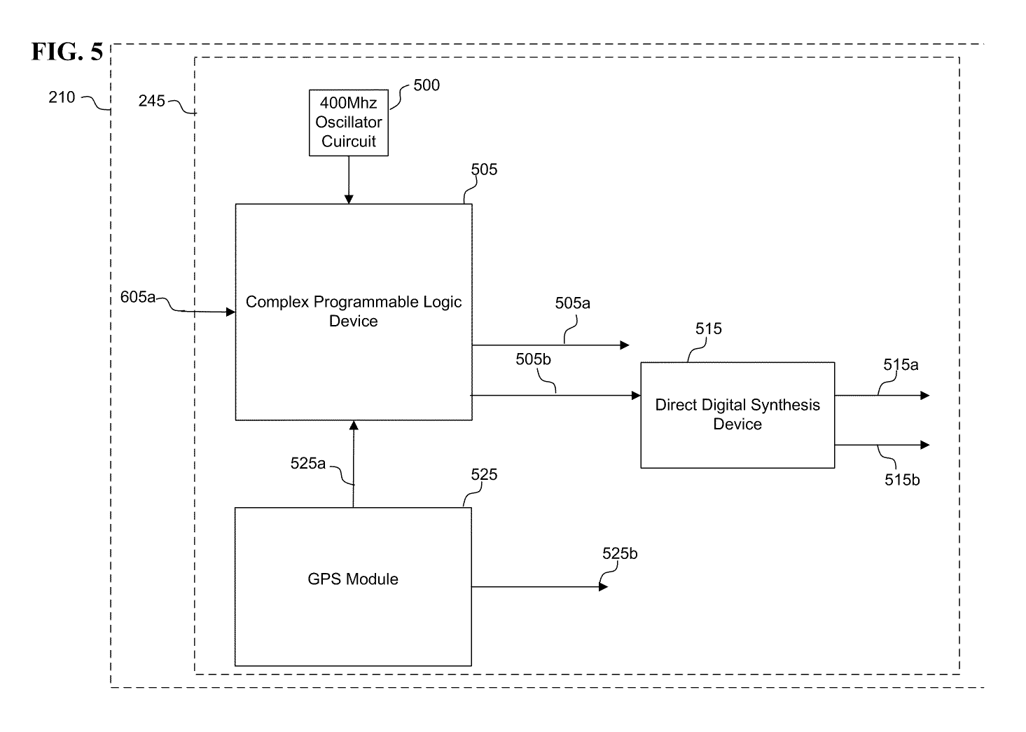

The tayloe detector circuits 355d and 355e are fed two 8,999,000 Hz clock signals, an in-phase clock signal 515a, and a quadrature out-of-phase clock signal 515b respectively. (Signals 515a and 515b are shown only in FIG. 5.) The signals 515a and 515b are generated from the same source in the timing module 600 (shown in FIG. 6), and are separated by a phase shift of 90 degrees. The tayloe detector circuits 355d and 355e generate an in-phase signal Ei present at 355f and a quadrature signal Eq present at 355g respectively, at frequencies between 0.01 Hz and 50 KHz. The in-phase signal 355f contains the amplitude information, and the quadrature signal 355g contains the phase information, of the original electromagnetic field signal ES3 at the output 310.

The Enhanced Tayloe detector circuit 355 can be understood by any person skilled in the art of superheterodyne radio frequency (RF) design.

The signals Ei, present at 355f, and Eq, present at 355g, are passed to bandpass diplexer networks 355h and 355i respectively. The outputs 360 and 365 of the bandpass diplexer networks are each buffered by low noise amplifiers 362 and 367 respectively. The low noise amplifiers 362 and 367 output a pair of signals 370 and 375 respectively that are each passed to the control module 250. The bandpass diplexer networks 355h and 355i can be understood by a person familiar with the art of RF radio design. An example of a diplexer design is at the Amateur and Short Wave Radio Electronics Experimenter's Web Site.

The three streams of digital data representing the instantaneous values of the signals Ei, present at 370, Eq, present at 375, and ES6, present at 325, over time are stored in the control module 250, in a bulk memory store 615. The data is stored in the industry standard SEG-D format.

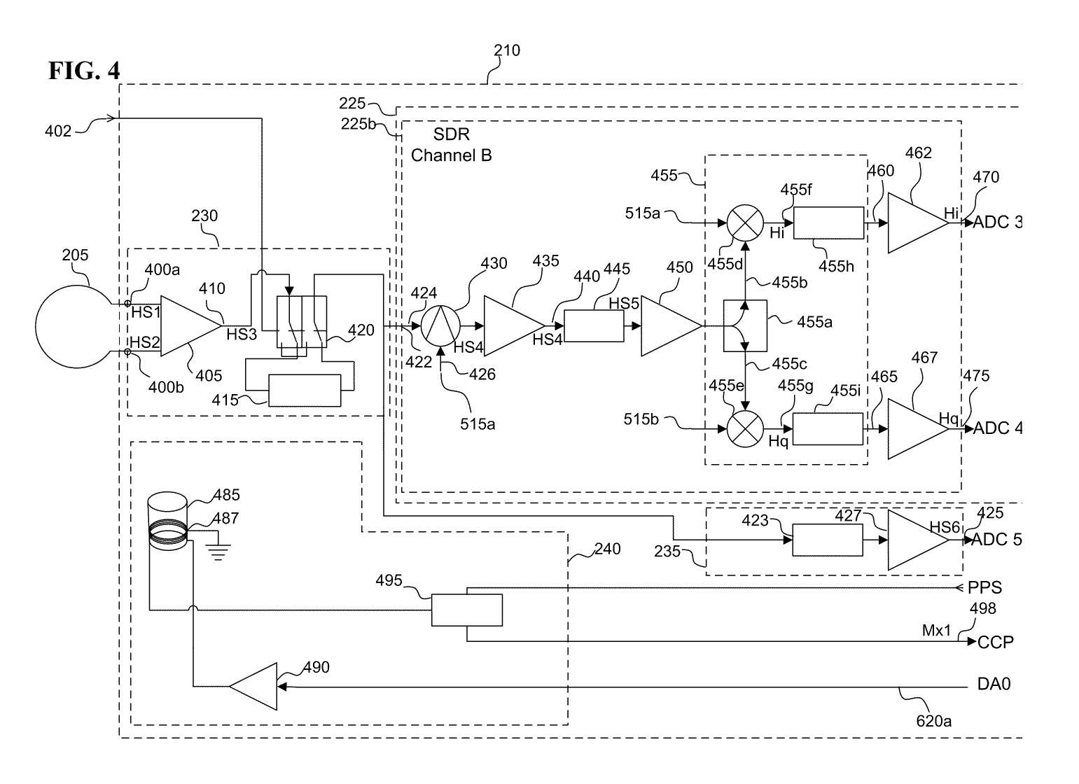

Referring now to FIG. 4, in the preferred embodiment the H-field detector consists of the loop antenna 205, the filter card 230, the magnetic point potential circuit 235, a second channel 225b of the SDR 225, and the magnetometer card 240.

The signals HS1 and HS2, from the magnetic field loop antenna 205, are present at inputs 400a and 400b. The inputs 400a and 400b are coupled to an H field filter card 230. The output of the H field filter card 230 is conductively coupled to channel 255b of the SDR 225. A second channel 225b of the SDR 225 has two output signals, Hi present at 470, and Hq present at 475, that are passed through to the control module 250.

The assembly, purpose, and operation of the circuit elements and sub elements within the depicted blocks 230, 225b, an Enhanced Tayloe detector (ETD) circuit 455, and 235, and the depicted sub elements 400a, 400b, 405, 410, 415, 420, 422, 424, 426, 430, 435, 440, 445, 450, 455a, 455b, 455c, 455d, 455e, 455f, 455g, 455h, 455i, 460, 465, 462, 467, 470, 423, 427 and 425 in FIG. 4, are identical to those of the elements 215, 225a, 335 and 220, and the depicted sub elements 300a, 300b, 305, 310, 315, 320, 323, 327, 326, 330, 335, 340, 345, 350, 355a, 355b, 355c, 355d, 355e, 355f, 355g, 355h, 355i, 360, 365, 362, 367, 270, 375, 322, 324 and 325 respectively in FIG. 3, as recited in the description for FIG. 3.

In an alternate embodiment the wire loop in the loop antenna 205 is replaced by a solenoid. The solenoid is a wire wound core with a high number of turns of Linz wire, and is center tapped.

The signal 620a (see FIG. 6) is passed to the buffer 460 and to the field null coil 487. The signal 620a can be derived from a potentiometer or the output of a Digital to Analog converter 620 (see FIG. 6) and is used to null the local magnetic field from the magnetometer

At least one of the outputs on an X-axis magnetometer 485 can be coupled to at least one of the three inputs in the magnetometer card 240. Local ambient field effects are negated by a field coil 487, as is typical in CSEM systems. In the preferred embodiment the X-axis magnetometer 485 is designed to detect fields that are parallel to the earth's surface. At least one of the magnetometer outputs is coupled to a divide-by-n counter 495. The output of the divide-by-n counter 495 is passed to a capture-and-compare input in a microprocessor in the control module 250.

The four signals, Hi present at 470, Hq present at 475, HS6 present at 425, and Mx1 present at 498, are passed to the control module 250. The four streams of digital data representing the instantaneous values of the signals Hi, Hq, Hs4, and Mx1, over time are stored to the control module 250, in a bulk memory store 615. The data is stored in the industry standard SEG-D format.

Referring to FIG. 5, the timing module 245 receives at least one low drift, phase accurate timing signal. In the preferred embodiment the master clock is sourced from a 400 Mhz oscillator 500. In the preferred embodiment, the oscillator is the NBXSBB023 400 Mhz LVPECL clock oscillator selected for 20 ppm accuracy, manufactured by On Semiconductor of Phoenix, Ariz.

The 400 Mhz oscillator 500 is connected a Complex Programmable Logic Device (CPLD) 505. The signal is divided down to a 50 Mhz clock signal 505a and a 27 Mhz clock signal 505b. In the preferred embodiment, the CPLD 505 is the Xilinx 3C256 CPLD, manufactured by Xilinx, Inc. 2100 Logic Drive, San Jose, Calif. 95124 U.S.A. The CPLD 505 is partially programmed as a divider, and is controlled by the control module 250 through a control bus 605a (shown in FIG. 6). The 50 Mhz clock signal 505a is coupled to a Direct Digital Synthesis (DDS) device 515, the semiconductor AD 9958 manufactured by Analog Devices Inc of Norwood Mass., USA. The DDS device 515 is used to create two clock signals. The first clock signal is in phase with the 400 Mhz oscillator 500, and is the in-phase clock signal 515a. The second clock signal is offset by 90 degrees in phase from the 400 Mhz oscillator 500 and is the out-of-phase clock signal 515b . The in-phase clock signal 515a and the out-of-phase clock signal 515b are fed to the Enhanced Tayloe circuits 355 and 455. In addition the in-phase clock signal 515a is fed to the mixer circuits 330 and 430. The 27 Mhz clock signal 505a is supplied to the ADC 600 (shown in FIG. 6).

The CPLD 505 is synchronized to other receiver systems 100, through a synchronization pulse 525a from a GPS module 525. An exemplary piece of equipment to perform receiver system location and synchronization is a PG11 Global Positioning System receiver, manufactured by Laipac Tech of Richmond Ontario Canada. Synchronization of the CPLD 505 using the synchronization pulse for the GPS module 525, coupled with compensation for distance to satellite delays, provides for a method to completely synchronize all the receivers and transmitters in a CSEM setup.

In addition, a GPS serial data stream 525b is passed to the control module 250 for storage of location information.

In an alternate embodiment the 400 Mhz oscillator circuit 500 is input into a low jitter, low phase noise clock distribution semiconductor (CDS). The CDS generates the 27 Mhz clock 505a, for the ADC 600 and the 50 Mhz clock 505b for the DDS device 515. An example of a CDS is the AD 9521, manufactured by Analog Device Inc, Norwood Minn. U.S.A.

In another alternate embodiment the master clock is a rubidium atomic clock. In another alternate embodiment synchronization can also be achieved through a timing module 605, shown in FIG. 6.

Referring to FIG. 6, the control module 250 receives a plurality of signals 602 from the E surface electric current detector circuit 220, the magnetic point potential circuit 235, and the two channel SDR 225. The signals 602 pass through a plurality of clipper circuits 625 that are used to limit the amplitude of the input to the ADC 600. The ADC 600 can sample the incoming signals at any rate from 3.0 K samples per second (sps) to 255 K sps. The ADC 600 allows for significant oversampling of the data stream. In the preferred embodiment, the ADC 600 is the AD 1278 manufactured by Analog Device Inc, Norwood, Minn.

The clipper circuits 625 are synchronized by a signal 630 from the microprocessor 605 that uses data from the magnetometer card 240 to detect the air wave. The signal from the magnetometer card 240 causes the clipper circuit 625 to attenuate the received signals 602 until the airwave has passed. The signals 602 pass into the ADC 600 and are converted to a digital data stream that is passed to a microprocessor 605. In the preferred embodiment, the microcontroller 605 is the AVR32 manufactured by Atmel of San Jose, Calif.

The microprocessor 605 moves the data stream from the ADC 600 and stores the data stream in a bulk memory 615. The microprocessor also receives location information from the GPS serial data stream 525b and stores the data in the bulk memory 615.

A communications module 610 connects to a user interface (UI) 625. The UI 625 can be used to adjust and control aspects of the operation of the receiver system 100. In the preferred embodiment the UI 625 consists of a display and a user input device. In an alternate embodiment of the UI 625, the input is achieved through a series of switches and potentiometers.

A Digital to Analog Converter (DAC) 620 outputs a signal that is varied under microprocessor control until the ambient magnetic field is nulled in the X axis magnetometer 485.

Referring to FIG. 7, a software control program 700 executes on the microprocessor 605. The software control program 700 consists of a series of steps that can be controlled or adjusted by input from the user interface (UI) 625. The software control program 700 reads the input settings in step 705 from the front panel of the UI 625, and saves the settings to the bulk memory 615. The input settings define the SDR 225 by setting the up-converter frequency for the in-phase clock signal 515a, the down converter frequency for the in-phase clock signal 515a, and quadrature clock signal 515b of the enhanced Tayloe detectors 355 and 455. The combination of setting the up-converter frequency and the down converter frequencies creates an accurate software-defined band pass filter with a software-controlled center frequency.

In step 710, the software control program 700 initializes the flash file. Step 715 normalizes the magnetometer 485 to the linear region of operation. Step 720 waits for the air wave to be detected. Once the air wave has been detected, step 725 starts the DDS device 515 and CPLD 505 at a precise start time using the GPS Module 525 synchronization pulse 525a.

In step 730 the ADC 600 data rate is set initially to 190 Khz, and the ADC 600 is started. In step 735 the processor reads the ADC 600 data on an end of conversion interrupt from the ADC 600. In step 740 the data is stored in a standard format to the bulk memory. In step 745 the user interface display is updated, and any required data transmission is done through the communications module 610.

The system returns to step 735 to await the next end of conversion interrupt from the ADC 600. The system continues in a loop 750 until all data has been collected and stored into bulk memory 615. In an alternate embodiment, the step 705 includes the addition of entering, via the UI 625, a pre-defined range of frequencies that the SDR 225 will sweep through during data collection.

In operation, a plurality of receiver systems 100 are arranged as depicted in either FIG. 1A or FIG. 1B. The receiver systems 100 are all synchronized through the synchronization pulse generated by the GPS module 225 in each receiver. In addition, location information is stored from the GPS module 225, along with the SEG D data saved in the bulk memory 615. The CSEM transmitter 102 is also capable of synchronization from a GPS synchronization pulse.

Once a transmitted wave has been generated, each receiver detects the air wave, and attenuates the data to the ADC 600 present in each receiver system 100. Once the air wave has passed, each receiver system begins collecting data.

The E field dipole receiver 200 is designed to detect changes in the electric field created by an active transmitter pulse or passively from spontaneous potentials.

The H field loop antenna 205 is designed to detect changes in the ambient magnetic field in all orientations, except those parallel to the earth's surface, caused by induced eddy currents in underground formations. The eddy currents induce magnetic fields that are of short duration. The loop antenna 205 is of typical design for this application, and varies in diameter dependent on depth of investigation required. The diameter can exceed 150 meters. The magnetometer card 240 provides the last axis of information that is combined with the magnetic field loop antenna 205 axis information, to determine the source of the arriving magnetic waves.

The received difference signals ES3 and HS3 are processed as depicted in FIGS. 3 and 4 respectively. Referring to FIG. 3, the combination of the mixer circuit 330, Cohn filter and diplexer circuit 345, and the enhanced Tayloe detector circuit 355, result in phase coherent, noise-free data.

In operation the Cohn filter and diplexeor circuit 345 is used in the band pass mode, and software executing on the microprocessor 605 controls the center frequency of the bandpass filter by controlling the up-converter frequency in the mixer circuit 345. The skirts of the Cohn filter and diplexer circuit 345 are very tightly defined and drop off at better than −70 db per decade, and allow the SDR 225 to provide a bandpass that can be set to different frequencies of interest. The frequency content of the incoming signal ES3 present at 310 is reduced to the range of interest at the up-converted frequency. The Cohn filter and diplexer circuit 345 is also known as a minimum loss filter, and has very high Q factors, in excess of 10,000.

The benefit of using this technique to filter out unwanted signals from ES3 and HS3 can be understood by any person skilled in the art of superheterodyne-based Software Defined Receivers. In addition, this method brings added benefit to the post-processing of data, because the frequency of the recorded data is tightly defined, and provides additional constraints for data processing.

The signal that results from the Cohn filter and diplexer circuit 345 has low noise content and low phase shift. The signal passes through the enhanced Tayloe detector 355, is down converted as a result of the function of the Tayloe detectors, and is split into amplitude (in-phase signal) and phase (quadrature signal) components, again with low noise content and good phase accuracy.

The data in the form of amplitude and phase pairs for each of the electric and magnetic fields is passed to the ADC 600.

It is an important element of the current invention that each channel of data being processed by the ADC 600 in the control module 250 has its sample start time synchronized in the pico second, or shorter, time frame. In addition, due to conductor line latencies, the time-critical ADC conversions all occur on a single chip, the AD 1278, and are concurrent to within 50 pico seconds. There are other latencies in the system, partly due to cable length variations and other factors that must also be measured. This is done by applying a test signal from the transmitter that is synchronized with the receivers, using a precise clock, and monitoring for arrival times at each of the ADC 600 inputs, and synchronized against a precise clock. This procedure must be performed for all receivers in the system and a calibration factor is programmed for each channel in the factory.

The system collects amplitude, phase and point potential data from the magnetic (H) field that is stored in the bulk memory 615. The phase data storage of the H field is unique to the current invention.

The present invention benefits from the use of the enhanced Tayloe detector circuit 225 in each of electric and magnetic receiver channels, and the high speed ADC 600, because the recorded data has a low signal-to-noise ratio, better than −120 dbm, and low phase distortion, less than 0.01%. The data stored in the bulk memory 615 includes additional data that creates a rich data set. The additional data items are a magnetic quadrature output signal Hq present at 475, a surface current signal ES6 at output 325, and a magnetic point potential signal HS6 at output 425. The data are all synchronized to the system clock, or to an atomic clock, or to a GPS synchronization pulse. The precise timing of all ADC acquisition cycles allows for improved resolution at sub-surface depths, beyond 10,000 meters. In addition, reduced “bin” size is achieved.

A “bin” in this context is a location of a finite size, usually a cube, within a mathematical representation (2D, 3D, or 4D array) of sub-surface geology. The bin is used to accumulate some predetermined value or combination of values for the location in the sub-surface geology.

The preceding is merely a detailed description of one (or more) embodiments of the invention. Numerous changes to the disclosed embodiments can be made in accordance with the disclosure herein, without departing from the spirit or scope of the invention. The preceding description, therefore, is not meant to limit the scope of the invention. Rather, the scope of the invention is to be determined by only the appended claims and their equivalents.

What is claimed is:

1. A method of improving the visualization of sub-surface formations, comprising the steps of:
(a) Placing a plurality of receiver systems on the surface of the earth to form a receiver matrix;
(b) Placing a CSEM transmitter on the surface of the earth, at a distance greater than five hundred meters from a center of the receiver matrix;
(c) Synchronizing the receiver systems and the CSEM transmitter;
(d) Generating a CSEM transmitter pulse;
(e) Waiting for a generated air wave to pass;
(f) Detecting changes in the electric fields of the sub-surface formations induced by the CSEM transmitter pulse;
(g) Detecting changes in the magnetic fields of the sub-surface formations induced by the CSEM transmitter pulse;
(h) Determining the sources of arriving electromagnetic waves;
(i) Up-converting received signals at a received frequency to a higher frequency to create up-converted signals;
(j) Using an RF bandpass filter to filter out unwanted signals from the up-converted signals to create filtered signals;
(k) Preserving both phase and amplitude information from the received signals; and
(l) Down-converting the filtered signals to the received frequency.

2. A system for improving the visualization of sub-surface formations, comprising:
(a) A plurality of receiver systems on the surface of the earth, forming a receiver matrix;
(b) A CSEM transmitter on the surface of the earth, at a distance greater than five hundred meters from a center of the receiver matrix;
(c) Means for synchronizing the receiver systems and the CSEM transmitter;
(d) Means for generating a CSEM transmitter pulse;
(e) Means for detecting changes in the electric fields of the sub-surface formations induced by the CSEM transmitter pulse;
(f) Means for detecting changes in the magnetic fields of the sub-surface formations induced by the CSEM transmitter pulse;
(g) Means for determining the source of arriving electromagnetic waves;
(h) Means for up-converting received signals at a received frequency to a higher frequency to create up-converted signals;
(i) Means for filtering out unwanted signals from the up-converted signals to create filtered signals;
(j) Means for preserving both phase and amplitude information from the received signals; and
(k) Means for down-converting the filtered signals to the received frequency.
